(19) United States
(12) Patent Application Publication
(10) Pub. No.: US 2008/0016162 A1
(43) Pub. Date: Jan. 17, 2008

(54) Method and Device for Monitoring the Traffic of Electronic Messages

(76) Inventors: Christian Meentzen, Grasberg (DE); Marco Monsees, Bremen (DE)

Correspondence Address: GOTTLIEB RACKMAN & REISMAN PC, 270 MADISON AVENUE, 8TH FLOOR, NEW YORK, NY, 10016-0601, US

(21) Appl. No.: 11/570,264

(22) PCT Filed: Jun. 13, 2005
(86) PCT No.: PCT/EP05/06296

§ 371 Date: Feb. 27, 2007

(30) Foreign Application Priority Data
Jun. 11, 2004 (DE) 102004 028 534.9

(51) Int. Cl. H04L 12/58

(52) U.S. Cl. 709/206

(57) ABSTRACT

The invention relates to a method and a device for monitoring outgoing electronic messaging traffic from a sender (1). To present a device for monitoring outgoing electronic messaging traffic sent by a sender (1), informing the user whether and which electronic messages have not reached their destination, or only with a delay, or have not been read by the recipient (2), it is proposed to provide:

receiving means for receiving information about a sent electronic message and for receiving a control message containing selected information about receipt and/or acknowledgement of the electronic message by a recipient (6),

storage means (9) for storing information for identifying the sent electronic message and a time period within which the control message is to be received, checking means (13) for checking the receipt of control messages,

correlation means (14) for correlating a received control message with the associated sent electronic message, based on the information for identifying the electronic message,

inspection means (15) for inspecting the content of the control message and

notification means (16) for outputting a notification when no control message has been received within the specified time periods, or when the control message indicates that an error occurred when the recipient (6) received and/or read the electronic message.

The invention relates to a method and a device for monitoring outgoing (outbound) electronic messaging traffic sent by a sender.

Today, almost all Internet users worldwide as well as many other users of electronic communication send electronic messages, e.g. e-mails, for exchanging information, in order to achieve better and faster efficiency of communication. Due to technical problems encountered by various e-mail service providers, recipients' systems or by the recipients themselves, e-mails sometimes fail to reach their destination, are extremely delayed, or are not read by the recipient.

It is therefore essential to receive information about e-mails that have not reached their destination, have been delayed, or have not been read. Until now, it has been possible to send e-mails from a sender to a recipient with a request to return a control message to the sender, containing selected information about receipt and/or acknowledgment of the e-mail. This is supported by appropriate functions, for example in e-mail software applications, for generating confirmation that the e-mail has been received or read.

For example, when many business e-mails are now sent with a request to return a control message, a corresponding number of control messages will also be received. This results in a large number of control messages at the sender, stating correct transmission of the e-mails, whereas a few control messages may indicate faulty transmission, or it may be the case that no control messages are received for a few e-mails. The disadvantage here is that the absence of a control message, or notification of faulty transmission can be easily overlooked.

A method is known from EP 0 371 605 A2 in which a database entry is produced for an e-mail when the user desires confirmation from his e-mail system that the e-mail has been received. Incoming (inbound) messages of confirmation are correlated to the e-mail and the user is informed about the confirmation of receipt. The disadvantage here is that when there are many such confirmations the user is not readily able to recognize that a confirmation is missing. Furthermore, the e-mail does not communicate information to the effect that the user desires a confirmation of receipt. What can happen, therefore, is that confirmations fail to be sent not because of faulty or missing receipt, but due to the fact that the recipient knows nothing about the sender's desire for confirmation and therefore does not issue a confirmation.

In the method known from U.S. Pat. No. 6,603,389, an electronic message is sent with a request to reply. If no reply is transmitted within a specified time period after receiving the electronic message, the user is informed accordingly. The aim is to ensure that a received message is also replied to within a specified time period.

U.S. Pat. No. 6,175,859 teaches a method with which entries in a database of electronic messages are checked for associated responses after a specified time period has elapsed. The method provides that the user receives information about possible alternative contact options from the recipient in the event that acknowledgment of the electronic message is prevented. The user is not informed about message transmission faults until after the specified time period has elapsed, so valuable time for a renewed electronic message or alternative form of contacting may be lost in certain circumstances.

In U.S. Pat. No. 6,108,688, a method is proposed in which, when sending an electronic message, a sending system generates a database entry on the basis of which checks are performed, by correlating incoming responses, to determine whether a confirmation desired by the user has been given by the recipient of the electronic message. If no response has been received when a predefined period of time has expired, the sending system generates a warning message. Although the user receives a warning message about non-receipt of the electronic message, the receiver does not receive any more detailed information about errors that may have occurred or which delimit the cause of error.

All known methods for monitoring or checking electronic messages envisage the response relating to the whereabouts and/or acknowledgment of an electronic message being sent back to the user along essentially the same path that the electronic message itself has also taken. More particularly, the user himself or the sending device used is the addressee of the response. Furthermore, the warning message is generated by the sending system itself. If the program constituting this sending system is terminated, the user does not receive any warning messages whatsoever. This leads to problems, especially when the user himself or the sending system can not be reached or can no longer be reached in this way, because the returned message ends up nowhere without any warning message being generated at all.

The object of the invention is to specify a device and a method for monitoring outgoing electronic messaging traffic from a sender, informing the user whether and which electronic messages have not reached their destination, or only with a delay, or which have not been read by the recipient. In particular, the user himself is to be informed.

This object is achieved by a device for monitoring outgoing electronic messaging traffic from a sender, said device comprising:

receiving means for receiving information about a sent electronic message and for receiving a control message containing selected information about receipt and/or acknowledgement of the electronic message by a recipient,

storage means for storing information for identifying the sent electronic message and a time period within which the control message is to be received,

checking means for checking the receipt of control messages,

correlation means for correlating a received control message with the respective sent electronic message, based on the information for identifying the electronic message,

inspection means for inspecting the content of the control message and

notification means for outputting a notification when no control message has been received within the specified time period, or when the control message indicates that an error occurred when the recipient received and/or read the electronic message.

The invention is based on the realization that it is more important for the user to be informed about electronic messages which have not reached their destination, or only with a delay, or which have not been read by the recipient, than it is to receive information about proper receipt and acknowledgment of electronic messages. The device according to the invention issues a notification, for example to the user, that only provides information about electronic messages whose transmission or receipt was faulty, or which have not been read, thus avoiding a multitude of control messages that can result in the absence of a control message being easily overlooked.

Firstly, the device according to the invention expects a control message within a given specified time period, for example about the receipt or acknowledgment of an electronic message. If a control message to that effect is not received due, for example, to the fact that the recipient has not yet read the electronic message, then a notification that this period has expired is sent on expiry of the specified time period, for example to the user and/or to some other previously specified person or entity.

Secondly, the device according to the invention also checks the content of the control message. If, for example information about receipt of an electronic message is expected, then a control message can report that the message has been successfully delivered, or that the message was not delivered or that an error occurred on delivery. For this reason, the content of a control message is also evaluated, and the user and/or other person or entity is notified accordingly.

In one advantageous embodiment, the device according to the invention also comprises analyzing means for extracting the information about the electronic message from the electronic message, the receiving means being configured to receive the electronic message. The sent electronic message is preferably monitored independently of the sender or the sending means used by the sender, the device being configured to analyze the sent electronic message on the way to the recipient, and the information necessary for monitoring being extracted from the electronic message itself.

If the monitoring device is separate from and independent of the sender, notification can be provided independently of the sender's status. When the control message is processed separately from the sender, monitoring devices and methods that have already been used can be re-used and need only be slightly modified, if necessary, to allow the electronic messaging traffic to be monitored in accordance with the present invention. Even conventional methods and systems for transmitting electronic messages that had not been suitable for monitoring electronic messaging traffic can interact in a simple manner with the device according to the invention, because all that is needed is to tag the outgoing electronic message in an appropriate manner, or to set the device accordingly.

In another embodiment, the receiving means is configured to forward the electronic message to the recipient. The device itself is thus involved in transmitting the electronic message from the sender to the recipient and thus receives access to or knowledge of an electronic message that has been transmitted. If the device itself assumes the function of a message forwarding device, it is possible to ensure that all electronic messages to be monitored are noticed by the device.

In one preferred embodiment of the invention, the monitoring device includes request means for attaching to the electronic message a request to return the control message. Conventional systems for sending electronic messages can thus be equipped with the device according to the invention without the sending transaction as such having to be modified. A device configured in this way also permits the user to dispense with tagging the electronic message with a corresponding request. In particular, it can be arranged that the device adds a corresponding request to electronic messages on the basis of preset parameters.

Nowadays, many different types of electronic messages are used. Among the best known are e-mails and SMSs (standing for “short message service”), while messages of the EMS (“enhanced message service”) or MMS (“multimedia message service”) type are becoming increasingly widespread. Other possibilities result from a more direct connection via the Internet using so-called peer-to-peer-systems, such as those using the ICQ protocol, which, unlike e-mails, require no servers or providers.

The control message can be of the same type as the sent electronic message, but can also be of some other type. An SMS, for example, can be sent as a control message for a sent e-mail.

In another advantageous embodiment of the invention, the receiving means is configured to receive the entire or a predetermined portion of the outgoing electronic messaging traffic from the sender, and/or the entire or a predetermined portion of the incoming messages in the form of control messages. When the monitoring system itself checks all or a portion of the incoming and/or outgoing messages, no modifications to existing methods are necessary besides channeling the messaging traffic through the monitoring system. In particular, it is not necessary to provide separate communication paths for those electronic messages which are to be monitored and those which are not to be monitored, thus allowing resources to be saved and confusion between the different communication paths to be avoided.

The sender and the device according to the invention can also be integrated in an application system. By integrating them in one application system, the monitoring system and the sender can be coordinated with each other in an ideal manner, and unnecessary interfaces where errors can occur are avoided.

In one preferred embodiment of the invention, the storage means is configured to store a first specified time period for receiving a first control message relating to receipt of the sent electronic message and a second specified time period for receiving a second control message relating to acknowledgment of the sent electronic message. In practice, what often happens is that a message is correctly delivered, but the recipient does not take notice of the message at all or not until after a delay. Different specified time periods for receipt and acknowledgment allow such cases to be recognized as well.

In another embodiment of the invention, the receiving means is configured to receive a respective control message from message forwarding devices involved in sending the electronic message from the sender to the recipient, and the storage means, the inspection means and the notification means are configured to process the respective time periods, inspections and notifications. Electronic messages such as e-mails are usually not sent directly from the sender to the recipient, but are routed and/or forwarded via one or more forwarding devices such as e-mail servers or other providers. Requests to return control messages and the respective processing of incoming control messages allow checks to be carried out at intermediate transmission points, if known before sending, and also allow early identification of any errors, such as unforwarded messages.

In yet another embodiment of the invention, the receiving means is configured to receive a plurality of control messages collated in one control message. It is not necessary to receive each control message individually. To reduce the volume of data and the number of control messages to be sent, different control messages can be collated in one control message.

In another preferred embodiment of the invention, the notification means is configured to output the notification as an electronic message, in particular as an e-mail, SMS, EMS, MMS or telephone call. When notification is provided in a way that is independent of the communication means with which the electronic message to be monitored was sent, it is possible to ensure that the user and/or some other person or entity the user specifies is notified in any event. If, for example, an e-mail has been sent, notification can also be sent by SMS to the user and/or the other person or entity. The notification could thus reach its destination even where the user switches off his computer or closes his e-mail program. More particularly, it can be provided in this connection that notification is given in several different ways and/or that the communication paths are selected on the basis of specific conditions. Examples of such conditions include the weekday, time of day or urgency of the notification. A notification during working hours could be given by e-mail, for example, whereas the path for times outside working hours would be SMS. The user's preferences that determine selection can be combined with the request to return a control message for each electronic message and/or be predefined for the monitoring system in some other way by the user, for example by adjusting one setting.

In other embodiments of the invention, the receiving means is configured to prevent a control message received by the device from being forwarded to the sender, or to tag a control message received by the device. When the control message has been inspected, it has achieved its purpose in the context of this invention and need no longer be heeded. In particular, it is not necessary to forward to the sender any control messages that have been processed and hence completed.

An inventive method according to claim 14 and a computer program according to claim 15 are also provided which comprise computer program code for controlling a computer in order to perform the steps of a method according to the invention when the computer program is run on a computer.

In a preferred configuration of the invention, the method according to the invention also comprises the steps of storing information in a monitoring system about the electronic message having been sent and about the request, and forwarding a received control message to the monitoring system, with checking, correlation, inspection and notification steps being performed by the monitoring system. When the control message is separately processed, monitoring methods that have already been used can be re-used and need only be slightly modified, if necessary, to allow the electronic messaging traffic to be monitored in accordance with the present invention.

The invention shall now be described in detail with reference to advantageous embodiments and the Figures, in which

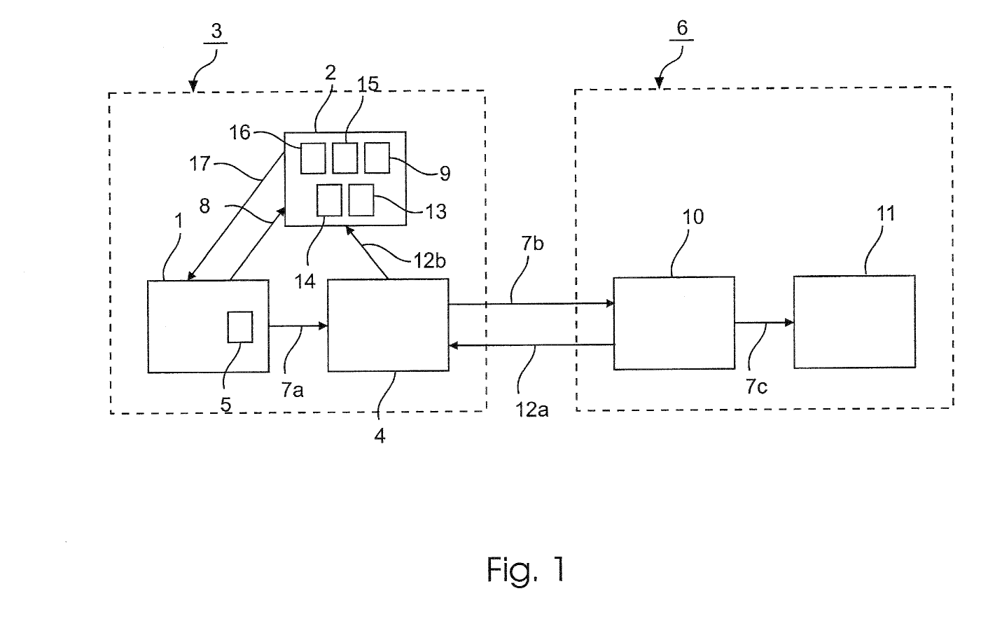

FIG. 1 shows a block diagram of a first embodiment of the invention applied to e-mail traffic,

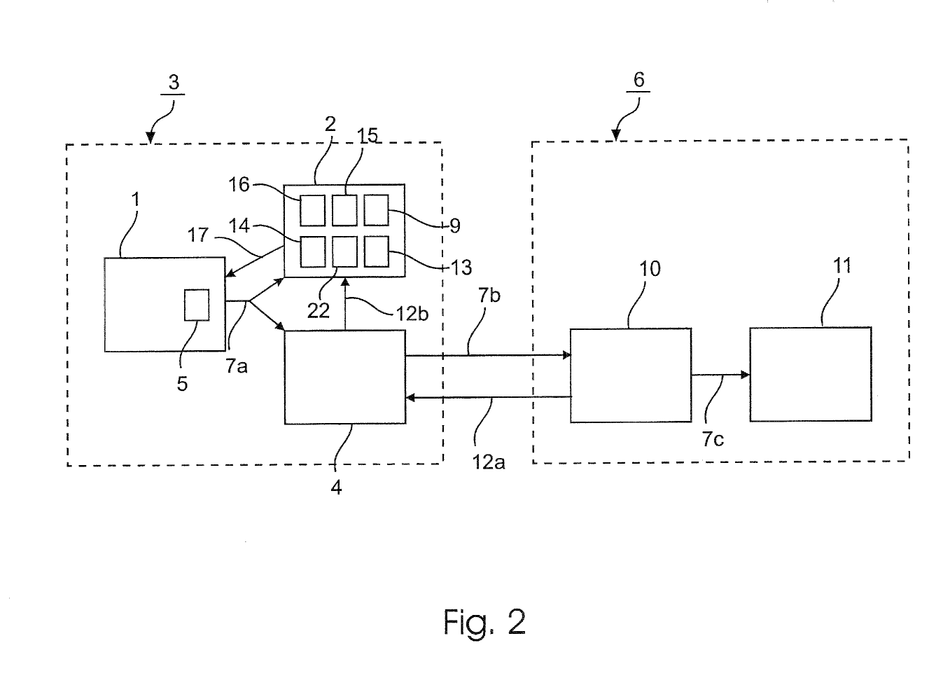

FIG. 2 shows a block diagram of a second embodiment of the invention applied to e-mail traffic,

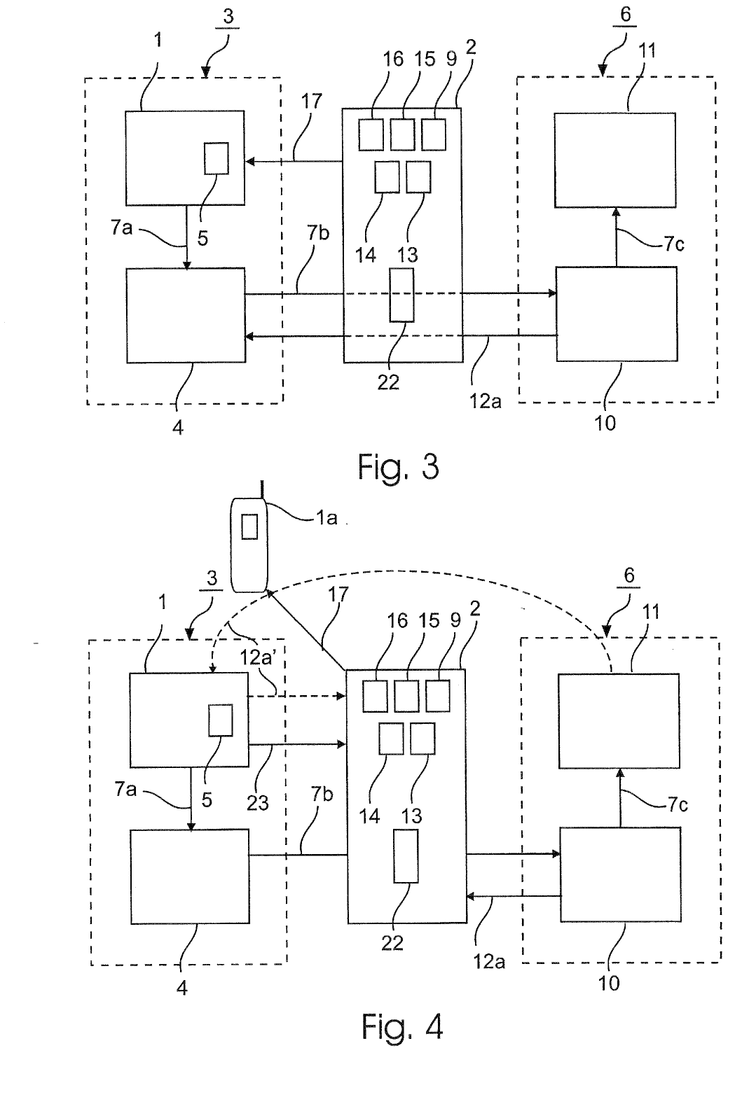

FIG. 3 shows a block diagram of a third embodiment of the invention applied to e-mail traffic,

FIG. 4 shows a block diagram of a fourth embodiment of the invention applied to e-mail traffic,

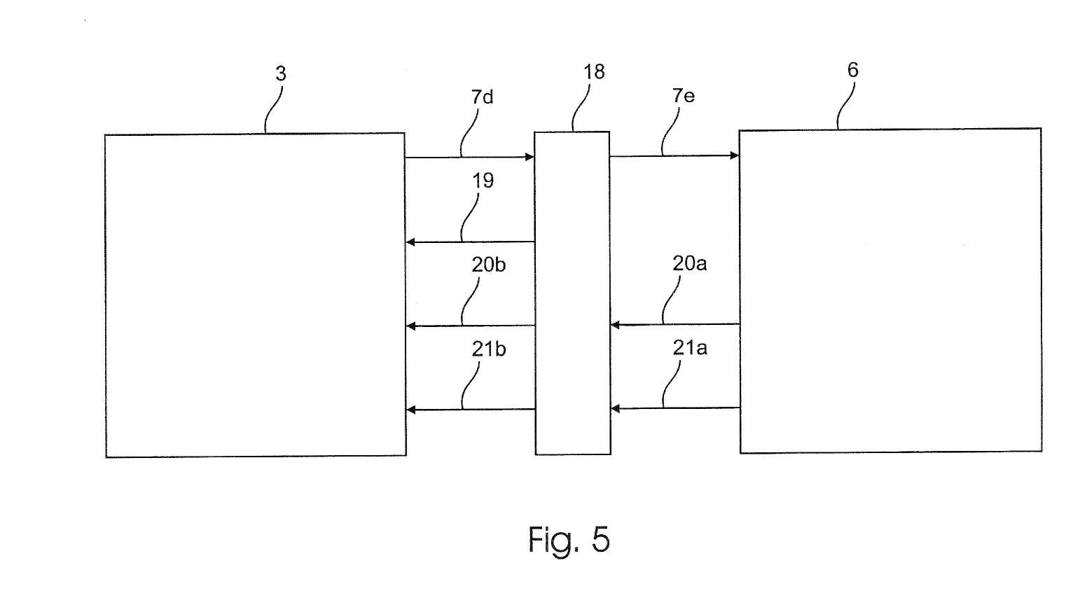

FIG. 5 shows a block diagram of a fifth embodiment comprising forwarding devices,

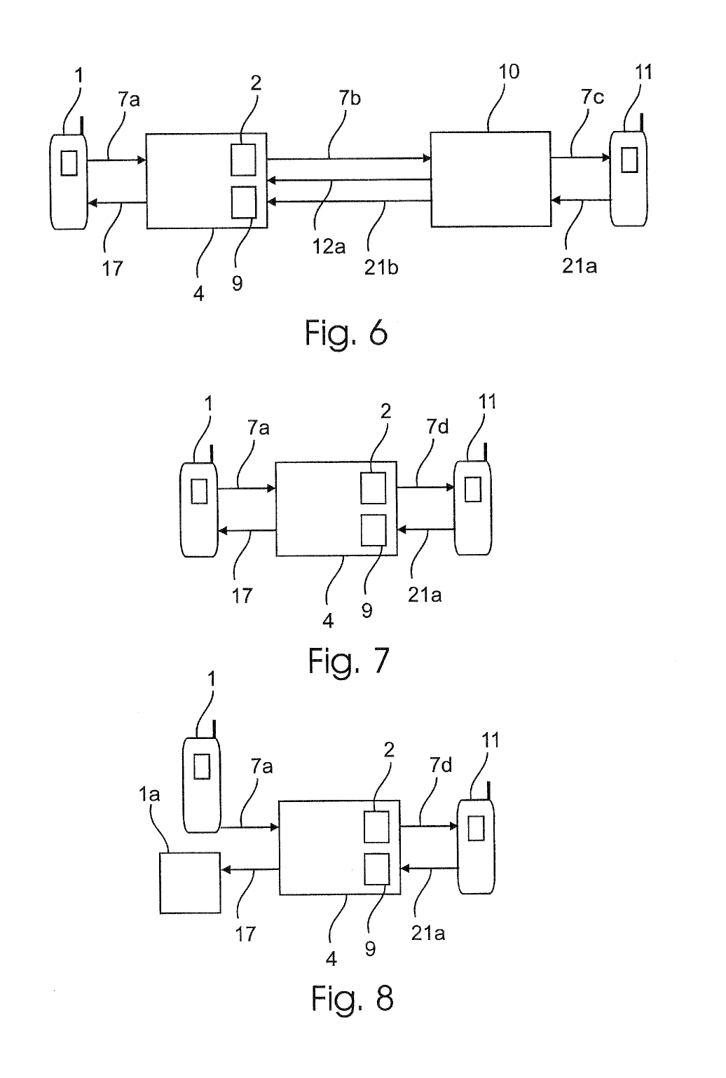

FIG. 6 shows a block diagram of a sixth embodiment applied to SMS traffic,

FIG. 7 shows a block diagram of a seventh embodiment applied to SMS traffic and

FIG. 8 shows a block diagram of an eighth embodiment applied to SMS traffic.

FIG. 1 shows a block diagram of a first embodiment of the invention for monitoring electronic messaging traffic applied to e-mail traffic. A sender 1 of e-mail e.g. a computer with an e-mail client and an Internet connection with which data can be sent and received, and a monitoring system 2 are combined to form an application system 3. Application system 3 also includes a server 4 for sending and receiving data to and from outside of application system 3.

Sender 1 comprises sending means 5 for sending an e-mail. The e-mail is joined to a request that instructs a recipient 6, for example, to send back a control message containing information about receipt or acknowledgment of the e-mail.

An e-mail 7a is passed from sender 1 to server 4, which sends e-mail 7b, and information 8 about the sender is stored in monitoring system 2 using storage means 9. Information about the requests attached to e-mail 7a, 7b and the respective time periods specified are contained in the stored information 8 along with information for identifying the e-mail. The information for identifying the e-mail can contain an unambiguous identification code, for example, such as a number or a sending time, a subject and/or recipient of the e-mail, and allow the anticipated control message to be correlated with the sent e-mail.

In the example shown, e-mail 7b is sent to recipient 6, which comprises a receiving server 10 and a receiving unit 11. A control message 12a about successful receipt by receiving server 10 and about successful forwarding 7c to the receiving unit 11 is sent to server 4. Server 4 forwards 12b this control message 12a to monitoring system 2.

Continuous or regular checks as to whether control messages have been received are performed in monitoring system 2, preferably by means of checking means 13. Control messages received are correlated with a sent e-mail using correlation means 14 on the basis of the information 8 stored in storage means 9, and the content of the control messages is checked using inspection means 15.

If, for example, the e-mail 7a, 7b has not been properly received by receiving server 10 or forwarded to receiving unit 11, this is recognizable for monitoring system 2 from control message 12a, 12b or from the absence of a control message, by performing an inspection with inspection means 15. In such a case, a notification 17 is given, e.g. as an e-mail, by monitoring system 2 to sender 1 using notification means 16, or directly to the user, e.g. in the form of an SMS to his mobile telephone, whereupon the user obtains knowledge of the error that has occurred and can draw the relevant conclusions or take counteractive measures. If the inspection shows that the electronic message was properly sent and acknowledged, no notification is sent unless specifically desired by the user. However, a notification 17 is also sent if, for example, the control message 12a, 12b about successful receipt of the sent e-mail has not been received within the time period specified in information 8.

In other embodiments of the method according to the invention, no server 4 need be provided in the application system, and the tasks of server 4 are then assumed by sender 1 or by monitoring system 2. This is like a peer-to-peer method. Receiving server 10 and receiving unit 11 can likewise be integrated in one unit at recipient 6. In addition, sender 1 and monitoring system 2 can be integrated in application system 3 in such a way that they are inseparable from each other. If necessary, it can also be provided that another control message be sent by recipient 6 or by receiving unit 11 via receiving server 10 to application system 3, stating that the electronic message 7a, 7b, 7c has been acknowledged.

The embodiment of the invention shown in FIG. 2 differs from the embodiment shown in FIG. 1 in that the message sent to monitoring system 2 is the electronic message 7a itself. Monitoring system 2 also includes analyzing means 22 for examining the electronic message and extracting the information to be stored.

Hence, electronic message 7a is also acknowledged by monitoring system 2 and analyzed by analyzing means 22. E-mail 7a is firstly analyzed by analyzing means 22 to determine whether it contains a request for a control message. When this is the case, information about the request and for identifying the e-mail is identified by further analyses of the e-mail.

A time period specifying by when a control message is expected is also extracted from the e-mail. The information thus extracted is stored in the monitoring system using storage means 9.

The control message is returned to the user of sender 1, it must be noted, so that monitoring system 2 can receive this control message. It is irrelevant here whether sender 1 or its users themselves actually receive the control message, because it has already served its purpose once it has been noticed by monitoring system 2.

It can also be provided that all or a predetermined portion of the outgoing electronic messages from server 4 and incoming electronic messages and control messages to server 4 are channeled through monitoring system 2 and that monitoring system 2 itself checks and evaluates these messages. A block diagram of this is shown in FIG. 3. Application system 3 includes sender 1 and server 4 only, the monitoring system being disposed between application system 3 and recipient 6 in such a way that it has access to the e-mails being sent here and can analyze them using analyzing means 22. Monitoring system 2 also has access to the returned control message 12a and is therefore able to process it.

FIG. 4 shows an embodiment comprising some independent variants. It must be noted that the variants described can be deployed individually or in any combination, also with other embodiments. As in the embodiment shown in FIG. 3, monitoring system 2 has access to the sent e-mail. However, control message 12 is received only by monitoring system 2 and does not reach application system 1, which is also unnecessary because the control message is appropriately used by monitoring system 2. It is also provided that any control message 12a′ which reaches sender 1 by some other path that is not available to monitoring system 2 is forwarded to monitoring system 2. The same could also apply to any control message that reaches any other communications device of the user. Sender 1 also sends presets 23 to monitoring system 2 that contain general stipulations for the monitoring system. In this way, it is possible to set general specified time periods, for example, so that the electronic message itself does not have to contain such time periods. Another example would be instructions to monitoring system 2 about how the user is to be notified. In the embodiment shown, the notification is not sent to sender 1 but to a different communications device of the user, in this case to a mobile telephone 1a. It can also be provided that the notification is sent to a completely different person or entity, for example to a network administrator, to a representative or to the secretary of the user. The notification can also be sent to several destinations.

FIG. 5 shows a block diagram of an embodiment of the invention, including a forwarding device 18. For greater clarity, the details of application system 3 and recipient 6 are not shown. Instead of the direct e-mail 7b sent from application system 3 to recipient 6, as shown in FIG. 1, it is provided that an e-mail 7d is first sent to a forwarding device 18, such as an additional server of a provider, and forwarded 7e to recipient 6 by forwarding device 18. When the e-mail has been forwarded, forwarding device 18 sends a forwarding control message 19 back to application system 3, where the message is processed accordingly. After e-mail receipt 7e and after acknowledgment of the e-mail, the recipient sends a respective control message 20a, 21a to forwarding device 18, which forwards control messages 20b and 21b to application system 3, where the control messages are processed accordingly. It is possible, of course, that more than one forwarding device 18 is involved, from which respective other forwarding control messages 19 are sent. It can also be provided that only one of control messages 20a, 21a is returned. Control messages can be returned directly to the application system or via one or more forwarding devices 18, whereby other forwarding devices 18 besides those provided for the transmission of electronic message 7d, 7e can be involved. In the embodiment shown here, monitoring system 2 is integrated into application system 3. As shown in FIGS. 2 and 3, monitoring system 2 can also be placed elsewhere in the communication path, for example between application system 3 and forwarding device 18.

FIG. 6 shows a block diagram of a sixth embodiment of the method according to the invention, for monitoring electronic messaging traffic such as SMS traffic. A sender 1 is provided, e.g. a mobile telephone or a PDA capable of sending short messages (SMSs) or similar or related electronic messages. An SMS 7a is sent with a request to return a control message about receipt and acknowledgment of the SMS is sent by sender 1 to a server 4, e.g. the mobile telephony provider, which includes a monitoring system 2.

Information about the request and respective time periods associated with SMS 7a is extracted from SMS 7a by server 4 or by monitoring system 2, as is information for identifying the SMS. The information is stored in storage means 9, to which monitoring system 2 has access.

In the example shown, SMS 7b is forwarded to a receiving server, for example to a different mobile telephony provider, which then sends SMS 7c to the recipient.

Receiving server 10 returns a control message 1 2a to server 4 notifying the latter that the SMS has been sent to receiving unit 11 and received by receiving unit 11.

When the SMS has been acknowledged in receiving unit 11, a control message 21a is sent by receiving unit 11 to receiving server 10 for forwarding as a control message 21b to server 4.

In this example, receiving unit 11 corresponds to recipient 6 in the previous examples.

Receipt of control messages 12a, 21b is regularly or continuously checked by monitoring system 2, and incoming control messages are correlated with sent SMSs and their contents inspected. For greater clarity, the respective means are not shown. If it transpires that SMSs 7a, 7b, 7c are not forwarded and received correctly, or at all, or not within the respective time period, or are not acknowledged at all or within the respective time period, a notification 17 is sent to sender 1 and/or directly to the user, who thus obtains knowledge of the error that has occurred and can draw appropriate conclusions or take further action.

Attention is drawn to the fact that the change in reference numerals for forwarded messages is applied here for the sole purpose of better distinguishing between the messages, and that the change is not intended to entail anything regarding whether or how the content of an electronic message is modified when forwarded.

Since all information about sent electronic messages and the respective incoming or anticipated control messages is available to the monitoring unit, the monitoring unit can provide the user, on request, with a corresponding status report.

FIG. 7 shows a seventh embodiment, which is a variant of the embodiment shown in FIG. 6. Here, messages are transmitted directly from server 4 to recipient 11, so no receiving server as such is provided, and the tasks of the latter are taken over by server 4.

As shown in FIG. 8, the notification 17 can also have a recipient other than sender 1. Notification 17 is sent here, by way of example, as an electronic message to a different communication means 1a of the user.

The method and corresponding device according to the invention allow the user of electronic messaging to establish with great certainty in electronic messaging traffic which of the electronic messages he has sent have not reached the recipient(s) as desired, or which have not been acknowledged. Since attention is drawn only to these faulty transmissions, a smaller number of notifications are sent to the user and the user can take better notice of such notifications. The monitoring system is independent of the actual transmission of the electronic message, and particularly of the sender, so the notification can be transmitted with greater flexibility. This makes it possible for the user to receive such notification independently of the status of his sender.

1. A device for monitoring outgoing electronic messaging traffic from a sender, comprising:
receiving means for receiving information about a sent electronic message and for receiving a control message containing selected information about receipt and/or acknowledgement of the electronic message by a recipient,
storage means for storing information for identifying the sent electronic message and a time period within which the control message is to be received,
checking means for checking the receipt of control messages,
correlation means for correlating a received control message with the associated sent electronic message, based on the information for identifying the electronic message,
inspection means for inspecting the content of the control message and
notification means for outputting a notification when no control message has been received within the specified time period, or when the control message indicates that an error occurred when the recipient received and/or read the electronic message.

2. The monitoring device according to claim 1, comprising analyzing means for extracting the information about the electronic message from the electronic message, wherein the receiving means is configured to receive the electronic message.

3. The monitoring device according to claim 1,
wherein the receiving means is configured to forward the electronic message to the recipient.

4. The monitoring device according to claim 1,
comprising request means for attaching to the electronic message a request to return the control message.

5. The monitoring device according to claim 2,
wherein the receiving means is configured to receive the entire or a predetermined portion of the outgoing electronic messaging traffic from the sender and/or the entire or a predetermined portion of the incoming messages in the form of control messages.

6. The monitoring device according to claim 5,
wherein the device is configured to monitor only electronic messages to be received that contain a request to return the control message.

7. The monitoring device according to claim 1,
wherein the storage means is configured to store a first specified time period for receiving a first control message relating to receipt of the sent electronic message, and a second specified time period for receiving a second control message relating to acknowledgment of the sent electronic message.

8. The monitoring device according to claim 1,
wherein the receiving means is configured to receive a respective control message from message forwarding devices involved in sending the electronic message from the sender to the recipient, and the storage means, the inspection means and the notification means are configured to process the respective time periods, inspections and notifications.

9. The monitoring device according to claim 1,
wherein the receiving means is configured to receive a plurality of control messages collated in one control message.

9. The monitoring device according to claim 1,
wherein the receiving means is configured to receive e-mails, SMSs, EMSs, MMSs or an electronic message using a peer-to-peer protocol.

10. The monitoring device according to claim 1,
wherein the notification means is configured to output the notification as an electronic message, in particular as an e-mail, SMS, EMS, MMS or telephone call.

11. The monitoring device according to claim 1,
wherein the receiving means is configured to prevent a control message received by the device (2) from being forwarded to the sender.

12. The monitoring device according to claim 1,
wherein the receiving means is configured to tag any control message received by the device.

13. The monitoring device according to claim 1,
comprising presetting means for assigning one or more specified time periods to all or to a predetermined portion of the received electronic messages and/or for specifying one or more requests for the request means.

14. A method for monitoring outgoing electronic messaging traffic from a sender, comprising the steps:
receiving information about an electronic message from a sender,
storing information for identifying the sent electronic message and a specified time period within which the control message is to be received,
checking the receipt of control messages,
correlating a received control message with the associated sent electronic message, based on the information for identifying the electronic message,
inspecting the content of the control message and
outputting a notification when no control message has been received within the specified time period, or when the control message indicates that an error occurred when the recipient (6) received and/or read the electronic message.

15. A computer program comprising computer program code for controlling a computers used to perform the steps of the method according to claim 14 when the computer program is executed on a computer.
